(19) United States
(12) Patent Application Publication
(10) Pub. No.: US 2016/0167471 A1
(43) Pub. Date: Jun. 16, 2016

(54) CHASSIS CONTROL ARM FOR A VEHICLE AND METHOD FOR THE PRODUCTION OF A CHASSIS CONTROL ARM

(71) Applicant: AUDI AG, Ingolstadt (DE)

(72) Inventors: ROLAND HUDLER, Manching (DE); FRIEDRICH-OSKAR WINTER, Nennslingen (DE); WOLFGANG SEEMÜLLER, Gilching (DE); HANS-JÜRGEN LANGHOFF, Lenting (DE); MATTHIAS Fuchs, Gaimersheim (DE)

(73) Assignee: Audi AG, Ingolstadt (DE)

(21) Appl. No.: 14/903,953

(22) PCT Filed: Jun. 7, 2014
(86) PCT No.: PCT/EP2014/001562

§ 371 Date: Jan. 8, 2016

(30) Foreign Application Priority Data
Jul. 11, 2013 (DE) 10 2013 011 589.2

(51) Int. Cl. B60G 7/00

(52) U.S. Cl. CPC B60G 7/001; B60G 2206/8103; B60G 2206/8201; B60G 2206/72; B60G 2204/418

(57) ABSTRACT

A chassis control arm for a vehicle includes an elongate control arm body which is made of a single piece metal sheet and shaped by bending such as to form two side walls in opposing spaced-apart relation. The side walls are connected at least in one section at their free longitudinal sides by a joining connection. The control arm body has axial ends, each provided with at least two coaxial bearing openings for receiving rubber-metal bearings, with at least one of the rubber-metal bearings having a cardanic rigidity which is lower than a torsional rigidity of the control arm body.

The present invention relates to a chassis control arm for a vehicle, including an elongate control arm body made of a single piece metal sheet and shaped by bending such as to form two side walls in opposing spaced-apart relation, with the side walls being connected at least in some sections at their free longitudinal sides by a joining connection, and having at each of its axial ends at least two coaxially arranged bearing openings, and at least one rubber-metal bearing, which is insertable into the coaxial bearing openings, and to a method for the production of such a chassis control arm.

Such chassis control arms are used in the wheel suspension of vehicles to guide the wheel under restriction to certain degrees of freedom relative to the body of the vehicle. A design of the chassis control arm involves the provision of a sheet metal blank, preferably made of an iron alloy, as a starting material, which is further processed in several processing steps, including forming and cutting, to a double-walled sheet metal control arm. This type of chassis control arm is distinguished mainly by its low material costs and production costs. In terminal bearing mounts, the chassis control arm is able to receive rubber-metal bearings for arrangement thereof to a wheel guide member (wheel carrier) and, on the other hand, to the body or the subframe.

DE 10 2010 010 665 A1 shows a stabilizing strut for a chassis of a vehicle, which has an elongate strut body made of metal sheet and having at a first longitudinal end at least one first eye and at a second longitudinal end at least a second eye. The strut body has at least such a curvature that the strut body lies at least in a partial region completely outside an imaginary straight connecting line between the at least one first eye and the at least one second eye. The strut body is composed of two individual sheet metal parts which are arranged on both sides of a longitudinal center plane. The two sheet metal parts are joined to one another between the at least one first eye and the at least one second eye at their peripheral edges on a longitudinal side of the sheet metal parts, which faces the imaginary straight connecting line over at least a partial length of this longitudinal side of the strut body, which partial length is at least 50% of the total length of this longitudinal side of the strut body. The confronting surfaces of the two sheet metal parts are spaced apart. The peripheral edges of the sheet metal parts on the longitudinal side, which faces away from the imaginary straight connecting line, are not joined, or at most joined to each other along a partial length of the longitudinal side of the strut body, which partial length is at most 30% of the total length of this longitudinal side. However, such a two-part structure of a chassis control arm has the disadvantage that it can be manufactured only at considerable expense, since both halves must be processed separately and then joined together.

DE 10 2008 015 393 A1 describes a chassis control arm of one-piece construction, with the two partial shells being interconnected at the back and formed by a further process step into a double-walled chassis control arm. The terminal bearing openings are provided to accommodate bearings.

DE 203 17 345 U1 discloses a chassis control arm for connection of two components, with a first mount for connection to the one component and a second mount for connection to the other component, with this chassis control arm being configured as a hollow body made of shell elements, which are formed from sheet metal. The two shell elements are interconnected at their abutting surfaces.

Object of the present invention is to provide an alternative embodiment of a chassis control arm for a vehicle, and a method for the production of such a chassis control arm.

This object is achieved by the features of claims 1 and 5, respectively.

A chassis control arm for a vehicle includes an elongate control arm body made of a single piece of sheet metal, which is shaped by bending such as to form two opposing spaced-apart side walls, with the side walls being connected to one another at their free longitudinal sides by joining at least in some sections, and by providing at each of its axial ends at least two coaxially arranged bearing openings, and at least one rubber-metal bearing which is insertable into the coaxial bearing openings, with the cardanic rigidity of at least one of the rubber-metal bearings being lower than the torsional rigidity of the control arm body.

By joining the side walls at their free longitudinal side at least in some sections, the torsional rigidity of the control arm body can be specifically adjusted to be higher than the cardanic rigidity of each of the at least one rubber-metal bearing. The side walls of the control arm body are formed in one piece on the longitudinal side, about which the control arm body is bent, while joined together on the opposite free longitudinal side. A uniformly constructed control arm body can thus be suited to the rubber-metal bearings at hand through appropriate configuration of the joining connection, without the need to make complex geometry or material adjustments. The configuration of the joining connection is thus dependent on the cardanic rigidity of each of the at least one rubber-metal bearing via the torsional rigidity of the control arm body that can be achieved. Without joining the free longitudinal sides of the side walls, the control arm body could thus have a lower torsional rigidity than the cardanic rigidity of the rubber-metal bearings. In particular when cast control arms are involved, significant cost advantages are thus afforded. The cardanic rigidity of the rubber-metal bearings could be deliberately selected high to overall improve the guiding characteristics of the chassis control arm. The rubber-metal bearings would be twisted when exposed to high loads anteriorly of the control arm body. The rubber-metal bearing preferably has a central bearing body for receiving a fastener, for example a screw, with the bearing body being surrounded by at least one elastomer layer, which is sheathed by a metal ring for the purpose of stable incorporation into the bearing opening. The rubber-metal bearing may also be designed as ball joint. Several such chassis control arm can be used in the wheel suspension of a vehicle. Iron wrought alloy is particularly suitable as metal sheet.

According to a preferred embodiment, the joining connection includes at least one face plate. The at least one face plate is suitable for bridging the distance between the side walls of the control arm body. It can be mounted to the side walls by any joining techniques. The arrangement of several face plates at different axial positions of the control arm body permits a variable adjustment of the torsional rigidity of the control arm body as a function of the cardanic rigidity of the rubber-metal bearings.

According to a preferred embodiment, the joining connection is configured as a material joint. Examples of material joints can include adhesive bonds or welded connections. The side walls can (partially) be joined with each other by a material joint directly or through interposition of at least one face plate. According to a particularly preferred embodiment, the material joint is formed as a welded connection. A welded connection can be made in a relatively reliable and cost-effective manner. The torsional rigidity of the control arm body can be variably adjusted over the length and disposition of the welding seam as a function of the cardanic rigidity of the rubber-metal bearings.

A method for the production of a chassis control arm according to the invention for a vehicle includes the following steps:
providing a plate-shaped semi-finished product for a control arm body having two side walls from a single-piece metal sheet;
introducing bearing openings in the axial ends of the side walls of the control arm body for receiving at least one rubber-metal bearing in a later method step;
shaping by bending the control arm body, in particular about an axis of symmetry, until the two side walls face each other in spaced-apart relation;
joining at least some sections of the side walls at their free longitudinal sides, with the joining connection being configured such that the torsional rigidity of the control arm body is higher than the cardanic rigidity of at least one of the rubber-metal bearings;
inserting the at least one rubber-metal bearing in the respective coaxial bearing openings.

By configuring the joining connection of the two side walls of the control arm body at their respective free longitudinal sides as a function of the ratio between torsional rigidity of the thus manufactured control arm body and the cardanic rigidity of the used rubber-metal bearings, with the torsional rigidity of the control arm body being higher than the cardanic rigidity of each of the rubber-metal bearing, it is easily possible to be able to suit the desired applications of the chassis control arm. For example, when using rubber-metal bearings with higher cardanic rigidity, the joining connection of the free longitudinal sides of the side walls of the control arm body can be configured more robust in terms of an increase in the torsional rigidity of the control arm body. The sequence of the method steps can be varied at the discretion of the artisan. Thus, the semi-finished product may already have the bearing openings for the rubber-metal bearings, which then face each other in coaxial relation after being shaped by bending. In a further method step, the finished control arm body can additionally be coated with a corrosion protective paint.

According to a preferred embodiment of the method, the joining connection includes at least one face plate. The at least one face plate is suitable for bridging the distance between the side walls of the control arm body. It can be connected by any joining techniques to the side walls. The arrangement of several face plates at different axial positions of the control arm body enables a variable adjustment of the torsional rigidity of the control arm body as a function of the cardanic rigidity of rubber-metal bearings.

According to a preferred embodiment, the joining connection is configured as a material joint. Examples of material joints can include adhesive bonds or welded connections. The side walls can (partially) be joined with each other by a material joint directly or through interposition of at least one face plate. According to a particularly preferred embodiment, the material joint is formed as a welded connection. A welded connection can be made in a relatively reliable and cost-effective manner. The torsional rigidity of the control arm body can be variably adjusted over the length and disposition of the welding seam as a function of the cardanic rigidity of the rubber-metal bearings.

According to a preferred configuration of the method, the control arm body is bent about a bending axis extending in its transverse extension.

Further details and advantages of the invention will become apparent from the following description of a preferred exemplary embodiment with reference to the drawings.

It is shown in:

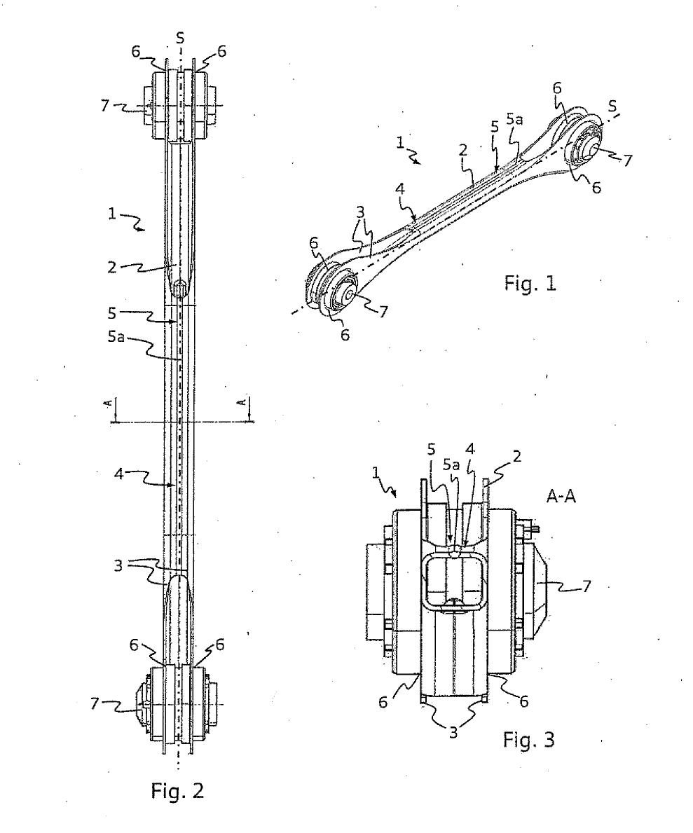

FIG. 1 an isometric view of a first embodiment of the chassis control arm;

FIG. 2 a plan view of a first embodiment of the chassis control arm;

FIG. 3 a sectional view of a first embodiment of the chassis control arm;

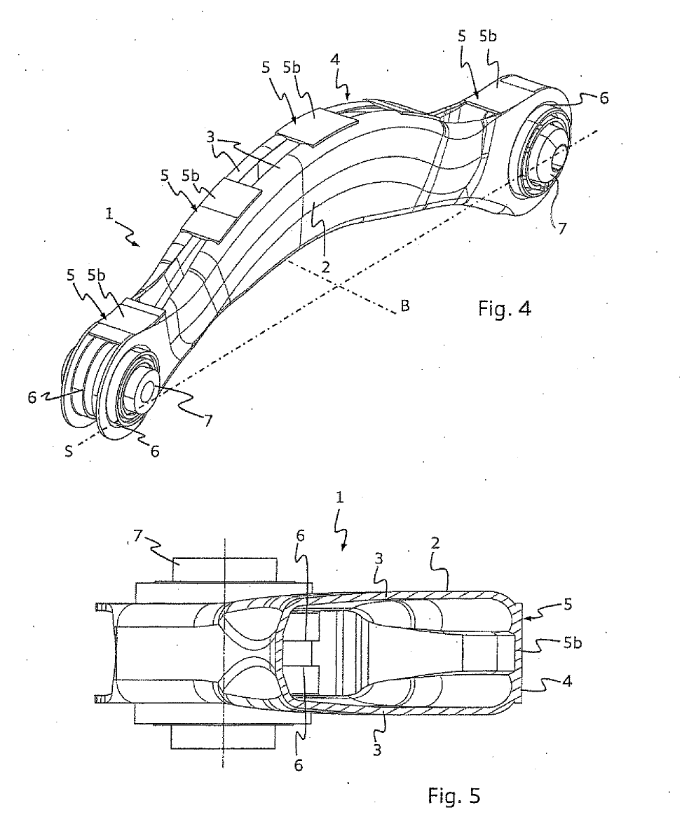

FIG. 4 an isometric view of a second embodiment of the chassis control arm;

FIG. 5 a sectional view of a second embodiment of the chassis control arm;

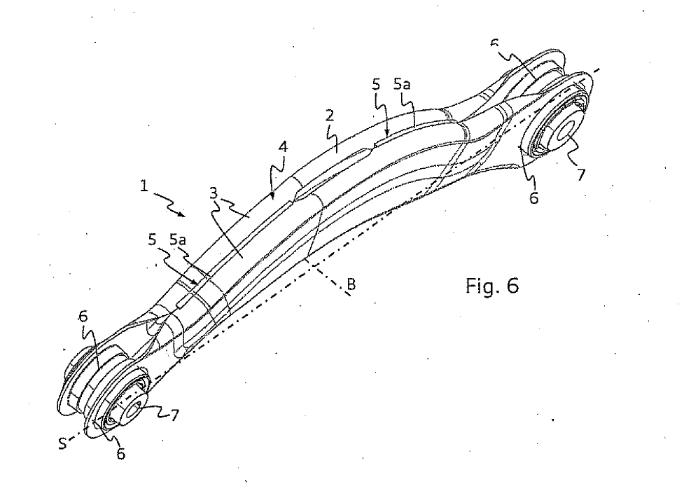

FIG. 6 an isometric view of a third embodiment of the chassis control arm.

According to FIG. 1, FIG. 2 and FIG. 3, a first embodiment of a chassis control arm 1 for a vehicle includes a control arm body 2 with two opposing side walls 3 in spaced-apart relation, which are connected at one longitudinal side in one piece with each other and at their opposing free longitudinal sides 4 by a joining connection 5 with each other. The joining connection 5 is realized in the present exemplary embodiment by a welded connection 5a in some sections. The control arm body 2 is manufactured from a metal sheet by shaping it through bending about its symmetry axis of S. Formed in the side walls 3 at the axial ends of the control arm body 2 are coaxial bearing openings 6, which are provided to receive rubber-metal bearings 7, respectively. The torsional rigidity of the control arm body 2 is higher as a result of the joining connection 5 than the cardanic rigidity of each rubber-metal bearing 7, and lower without joining connection 5.

According to FIG. 4 and FIG. 5, a second embodiment of a chassis control arm 1 for a vehicle includes a control arm body 2 with two opposing side walls 3 in spaced-apart relation, which are connected at one longitudinal side in one piece with each other and at their opposing free longitudinal sides 4 by a joining connection 5 with each other. The joining connection 5 is realized in the present exemplary embodiment by an arrangement of several face plates 5b in some sections which can be selectively bonded or welded with the side walls 3. The control arm body 2 is manufactured from a metal sheet by shaping it through bending about its symmetry axis of S. Formed in the side walls 3 at the axial ends of the control arm body 2 are coaxial bearing openings 6, which are provided to receive rubber-metal bearings 7, respectively. The torsional rigidity of the control arm body 2 is higher as a result of the joining connection 5 than the cardanic rigidity of each rubber-metal bearing 7, and lower without joining connection 5. The control arm body 2 is additionally bent about a bending axis B that extends in transverse direction of the control arm body 2.

According to FIG. 6, a third embodiment of a chassis control arm 1 for a vehicle includes a control arm body 2 with two opposing side walls 3 in spaced-apart relation, which are connected at one longitudinal side in one piece with each other and at their opposing free longitudinal sides 4 by a joining connection 5 with each other. The joining connection 5 is realized by a welded connection 5a in some section (here in two sections). The control arm body 2 is manufactured from a metal sheet by shaping it through bending about its symmetry axis of S. The control arm body 2 has additionally been bent about a bending axis B that extends in transverse direction of the control arm body 2. Formed in the side walls 3 at the axial ends of the control arm body 2 are coaxial bearing openings 6, which are provided to receive rubber-metal bearings 7, respectively. The torsional rigidity of the control arm body 2 is higher as a result of the joining connection 5 than the cardanic rigidity of each rubber-metal bearing 7, and lower without joining connection 5.

### LIST OF REFERENCE SIGNS

B bending axis
S symmetry axis
1 chassis control arm
2 control arm body
3 side wall
4 free longitudinal side
5 joining connection
5a welded connection
5b face plate
6 bearing opening
7 rubber-metal bearing

What is claimed is:

1.-9. (canceled)

10. A chassis control arm for a vehicle, comprising:
an elongate control arm body made of a single piece metal sheet and shaped by bending such as to form two side walls in opposing spaced-apart relation, with the side walls being connected at least one section at their free longitudinal sides by a joining connection, said control arm body having axial ends, each provided with at least two coaxial bearing openings; and
rubber-metal bearings configured for insertion into the coaxial bearing openings, respectively, at least one of the rubber-metal bearings having a cardanic rigidity which is lower than a torsional rigidity of the control arm body.

11. The chassis control arm of claim 10, wherein the joining connection comprises at least one face plate attached to the side walls.

12. The chassis control arm of claim 10, wherein the joining connection is formed by a material joint.

13. The chassis control arm of claim 12, wherein the material joint is formed as a welded connection.

14. A method for the production of a chassis control arm for a vehicle comprising the steps of:
providing a plate-shaped semi-finished product for a control arm body having two side walls from a single piece metal sheet;
introducing bearing openings in axial ends of the side walls of the control arm body for receiving rubber-metal bearings, respectively;
bending the control arm body such that the two side walls face each other in-spaced-apart relation;
joining at least one section of the side walls at their free longitudinal sides such that a torsional rigidity of the control arm body is higher than a cardanic rigidity of at least one of the rubber-metal bearings; and
inserting the at least one of the rubber-metal bearings in a respective one of the coaxial bearing openings.

15. The method of claim 14, wherein the joining step includes attaching at least one face plate to the side walls.

16. The method of claim 14, wherein the joining step is formed as a material joint.

17. The method of claim 16, wherein the material joint is formed as a welded connection.

18. The method of claim 14, further comprising bending the control arm body about a bending axis extending in a transverse extension of the control arm body.
